(19) United States
(12) Patent Application Publication
(10) Pub. No.: US 2014/0104871 A1
(43) Pub. Date: Apr. 17, 2014

(54) LIGHT MANAGEMENT FILM

(71) Applicant: 3M INNOVATIVE PROPERTIES COMPANY, St. Paul, MN (US)

(72) Inventors: Gary T. Boyd, Woodbury, MN (US); Qingbing Wang, Woodbury, MN (US)

(21) Appl. No.: 14/118,829

(22) PCT Filed: May 14, 2012
(86) PCT No.: PCT/US2012/037710

§ 371 Date: Nov. 19, 2013

Related U.S. Application Data
(60) Provisional application No. 61/488,270, filed on May 20, 2011.

(51) Int. Cl. F21V 8/00; G02B 5/04; G02B 5/30

(52) U.S. Cl. CPC G02B 6/0053; G02B 5/3025; G02B 5/045
USPC 362/606; 359/485.06; 359/831

(57) ABSTRACT

Example light management films including a plurality of tapered protrusions are described. In some examples, the disclosure relates to a film comprising a reflective polarizer layer and a plurality of tapered protrusions disposed on and tapering away from the reflective polarizer layer, where the tapered protrusions include at least one of a plurality of substantially conical shaped protrusions or a plurality of pyramidal shaped protrusions including at least four side faces. The plurality of tapered protrusions may be configured to reduce the divergence of incident light and redirect a majority of incident light propagating along a first direction to a second direction different from the first direction.

### TECHNICAL FIELD

The disclosure relates to display devices and, in particular, films that may be used in backlit display devices.

### BACKGROUND

Optical displays, such as liquid crystal displays (LCDs), are becoming increasingly commonplace, and may be used, for example, in mobile telephones, portable computer devices ranging from hand held personal digital assistants (PDAs) to laptop computers, portable digital music players, LCD desktop computer monitors, and LCD televisions. In addition to becoming more prevalent, LCDs are becoming thinner as the manufacturers of electronic devices incorporating LCDs strive for smaller package sizes. Many LCDs use a backlight for illuminating the LCD's display area.

### SUMMARY

In general, the disclosure relates to a light management film that may be used to redirect light, for example, in a backlit display device. The film may include a plurality tapered protrusions defining a surface of the film. The tapered protrusions may be in the form of a plurality of substantially conical shaped protrusions and/or a plurality of pyramidal shaped protrusions including at least four faces. In some examples, the film may include a reflective polarizer layer, in which case the plurality of protrusions may taper away from the reflective polarizer layer. When employed in a backlit display device, the film may be disposed between the light guide and display surface, and the plurality of protrusions may taper toward the light guide of the display and away from the display surface. In such an example, the plurality of tapered protrusions may be configured to reduce divergence of light incident upon surfaces of respective protrusions in at least one direction (e.g., two mutually orthogonal directions). Additionally, the plurality of tapered protrusions may be configured to redirect incident light such that for incident light propagating along a first direction, the protrusions redirect the majority of incident light along a second direction different than the first direction.

In one example, the disclosure is directed to a film comprising a reflective polarizer layer, and a plurality of tapered protrusions disposed on and tapering away from the reflective polarizer layer, wherein the plurality of tapered protrusions comprise at least one of a plurality of substantially conical shaped protrusions or a plurality of pyramidal shaped protrusions including at least four side faces, and wherein the plurality of tapered protrusions reduce divergence of light incident surfaces of respective protrusions in at least one direction and redirect a majority of the incident light such that for incident light propagating along a first direction, the protrusions redirect the majority of incident light along a second direction different than the first direction.

In another example, the disclosure is directed to a display device comprising a light source, a lightguide, an outer display surface, and a plurality of tapered protrusions between the light guide and outer display surface, and tapering toward the light guide, wherein the plurality of tapered protrusions comprise at least one of a plurality of substantially conical protrusions or a plurality of pyramidal-shaped protrusions including at least four faces, wherein light from the light source propagates through the light guide into the plurality of tapered protrusions, and wherein the plurality of tapered protrusions reduce divergence of light incident to surfaces of respective protrusions in at least one direction and redirect a majority of the incident light such that for incident light propagating along a first direction, the protrusions redirect the majority of incident light along a second direction different than the first direction.

In another example, the disclosure is directed to a film comprising a redirecting layer including a plurality of substantially pyramidal shaped protrusions, wherein each of the plurality of pyramidal shaped protrusions includes greater than four faces.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIGS. 1A and 1B are conceptual diagrams illustrating an example backlit display device.

FIG. 2 is a conceptual diagram illustrating an example light management film.

FIG. 3 is a conceptual diagram illustrating an example light management film and example lightguide.

FIGS. 4 and 5 are conceptual diagrams illustrating two different example reflective polarizer portions of an example light management film.

FIGS. 6 and 7 are conceptual diagrams illustrating two different example tapered protrusions.

FIGS. 8A and 8B are conceptual diagrams illustrating horizontal cross-sections of two different example tapered protrusions.

FIG. 9 is a conceptual diagram illustrating a vertical cross-section of an example tapered protrusion.

FIG. 10 is a conceptual diagram illustrating another example tapered protrusion.

FIG. 11 is an image showing simulated conoscopic input.

FIG. 12 is an image showing simulated output from an example film.

FIG. 13 is an image showing simulated conoscopic input.

FIG. 14 is a plot of luminance versus polar angle along a vertical plane for each of four example simulated films.

FIG. 15 is a plot of luminance versus polar angle along a vertical plane for two example simulated films.

FIG. 16 is a plot of axial luminance versus ratio of tip width to base width for example simulated films.

FIG. 17 is a plot of luminance versus polar angle for two example simulated film configurations.

FIG. 18 is a plot of luminance versus polar angle for five example simulated films.

FIG. 19 is an image showing simulated output generated by an example film including substantially pyramidal shaped protrusion with four side faces.

FIG. 20 is an image showing simulated output generated by an example film including substantially pyramidal shaped protrusion with ten side faces.

FIG. 21 is an image illustrating example protrusions.

FIG. 22 is an image showing an example array of conical shaped protrusions from a plan view.

FIG. 23 is a scanning electron microscope (SEM) image showing the example array of conical shaped protrusion in FIG. 22 from a perspective view.

FIG. 24 is a conoscopic image illustrating an example output from an example combination of lightguide and example film.

FIG. 25 is a conoscopic image.

FIG. 26 is a plot comparing the axial luminance for a variety of example film stacks.

FIG. 27 is an image showing simulated conoscopic input.

### DETAILED DESCRIPTION

In general, the disclosure relates to a light management film that may be used to redirect light, for example, in a backlit display device. The film may include a plurality tapered protrusions defining a surface of the film. The tapered protrusions may be in the form of a plurality of substantially conical shaped protrusions and/or a plurality of pyramidal shaped protrusions including at least four faces. In some examples, the film may include a reflective polarizer layer, in which case the plurality of protrusions may taper away from the reflective polarizer layer. When employed in a backlit display device, the film may be disposed between the light guide and display surface, and the plurality of protrusions may taper toward the light guide of the display and away from the display surface. In such an example, the plurality of tapered protrusions may be configured to reduce divergence of light incident upon surfaces of respective protrusions in at least one direction (e.g., two mutually orthogonal directions). Additionally, the plurality of tapered protrusions may be configured to redirect incident light such that for incident light propagating along a first direction, the protrusions redirects the majority of incident light along a second direction different than the first direction.

In some examples, a backlit display device may include of a light source, a lightguide, a Liquid Chrystal Display (LCD), and a stack of light management films between the lightguide and LCD. In such examples, light originating from the backlight may be used to illuminate the LCD after traveling through the lightguide, and stack of light management films. More specifically, light exiting a lightguide may travel through the stack of light management films before entering the LCD. The stack of light management films include a diffuser (referred in some instances as a bottom diffuser or BD), two prism films, a reflective polarizer (RP), and possibly an additional diffuser (referred to in some instances as a cover sheet or CS).

In some examples, a display device may include a rear reflector layer separated from the stack of light management films by the lightguide. The combination of the stack of light management films, lightguide, and reflective layers may be referred to as a backlight stack. For instances in which the layers of the backlight stack are oriented substantially parallel to the display surface of the LCD and the light source is adjacent to one or more edges, the backlight stack may include the rear reflector, lightguide, a BD, two prism films, RP, and CS going in that order from back to front. The prism films can consist of a clear substrate topped with a plurality of parallel linear prisms with 90 degree apex angles. The prisms of the rear most prism film may be oriented to generally run in a direction orthogonal to those of the front prism film. In such cases, the prism films may be described as being in a crossed orientation, and may be configured to redirect some of the light from the lightguide toward the LCD. A short hand notation for the backlight stack is CS/RP/prism film/prism film/BD/lightguide/reflector, where the order is from the front of the backlight to the rear of the backlight.

The light source and backlight stack of the display device may be configured to provide spatially an angularly uniform light illuminating the LCD with a relatively high level of efficiency. However, there continues to be a need to reduce the thickness of the backlight to make ever thinner backlit displays device, as well as reduce the materials and overall cost for constructing a backlight stack, while still maintaining a desirable level of performance. In some examples, the construction of a backlight stack and backlit display device may be complicated by the precision required when aligning the linear prism films relative to one another in a crossed orientation, and well as relative to the light source, lightguide and other components of the display device.

In accordance with some examples of the disclosure, a light management film may include a plurality of tapered protrusions. The plurality of tapered protrusions may include substantially conical shaped protrusions and/or substantially pyramidal shaped protrusions, where the substantially pyramidal shaped protrusions include at least four side faces. Such a film may be employed in a backlit display device between a lightguide and LCD. When incorporated into a backlit display device, the tapered protrusions may taper toward the lightguide and away from the LCD. For light passing through the light management film toward the LCD, the tapered protrusions may reduce the divergence of incident light and redirect a majority of incident light propagating along a first direction to a second direction different from the first direction.

In some examples, the light management film including a plurality of tapered protrusions may also include a reflective polarizer layer. The tapered protrusions of the redirecting layer may be disposed on (directly or indirectly) and taper away from the reflective polarizer layer. When employed in a backlit display device, the reflective polarizer layer may be separated from the lightguide by the plurality of tapered protrusions. In some examples, the light management film may include one or more other layers, such as, e.g., matte layers, clear layers, and/or adhesive layers in addition to that of the redirecting layer and reflective polarizer layer. In some examples, a light management film in accordance with some examples of the disclosure may allow for a single optical construction that may be placed between the surface of a lightguide and LCD in a backlit display device, e.g., as compared to the CS/RP/prism film/prism film/BD/lightguide/reflector configuration described above. In this manner, the overall thickness of a backlight stack for a backlit display device may be reduced as well as allow for a reduction in materials and overall cost for constructing a backlight stack.

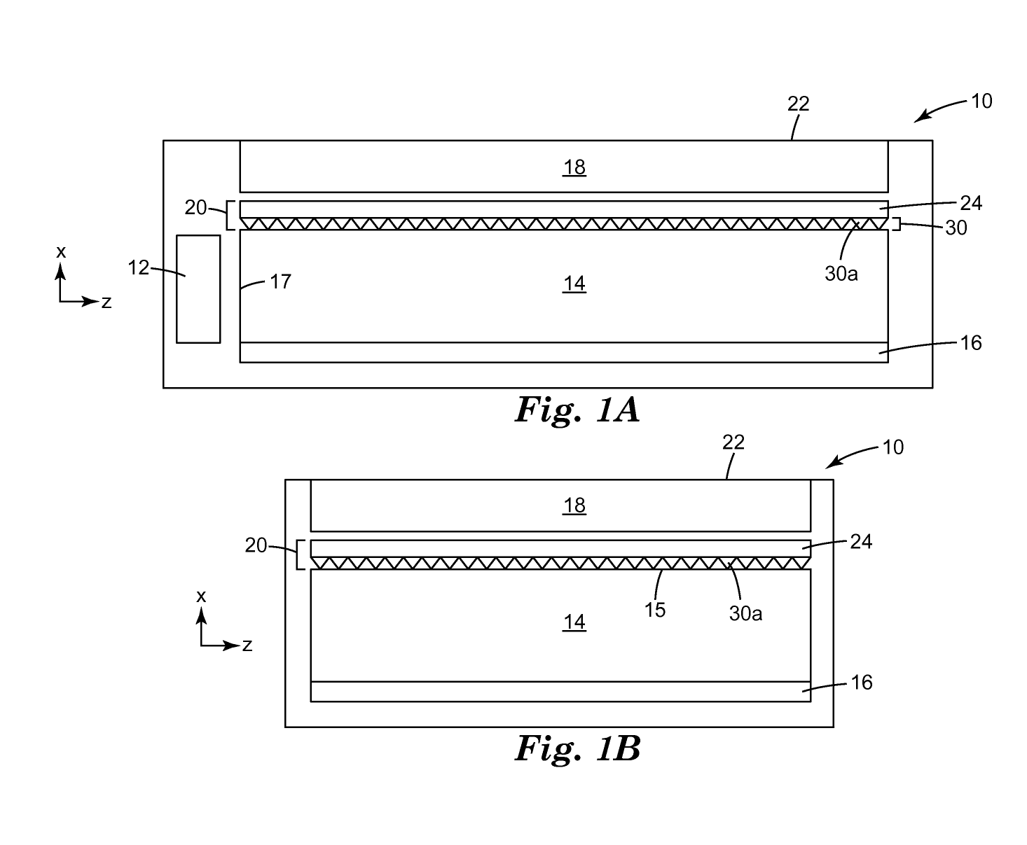

FIGS. 1A and 1B are conceptual diagrams illustrating example backlit display device 10. Backlit display device 10 includes light source 12, lightguide 14, reflector 16, LCD 18, and light management film 20. As shown, light management layer includes reflective polarizer layer 24 and plurality of tapered protrusions 30. For ease of illustration, only a single protrusion 30A is labeled in FIGS. 1A and 1B. However, throughout the disclosure, the individuals protrusions, such as, single protrusions 30A, may be collectively referred to as “plurality of tapered protrusions 30.” Although backlit display device 10 is illustrated with a single light source 14 adjacent to one edge 17 of lightguide 14, other configurations are contemplated. For example, backlit display device 10 may include more than one light source 12 adjacent to one or more surfaces of lightguide 14.

Light source 14 may be any suitable type of light source such as a fluorescent lamp or a light emitting diode (LED). Furthermore, light source 14 may include a plurality of discrete light sources such as a plurality of discrete LEDs. To illuminate the outer display surface 22 of LCD 18, light from light source 14 propagates through lightguide 14 in the general z-direction. At least a portion of the light exits through upper surface 15 of light guide 14 into light management film 20. Reflector 16 is located below lightguide 14, and reflects light back towards light management film 20.

A portion of the light entering light management film 20 from lightguide 14 may be redirected by plurality of tapered protrusions 30 before entering reflective polarizer layer 24. For example, some light may be refracted in the general direction (z-direction) of reflective polarizer layer 24 and LCD 18, while other portions of the light from lightguide 14 may pass through plurality of tapered protrusions 30 without being redirected. In some examples, plurality of tapered protrusions 30 may redirect light incident with respect to the lightguide surface of protrusions 30 such that for incident light propagating along a first direction, the protrusions 30 redirect the majority of incident light along a second direction different than the first direction passing through plurality of tapered protrusions. The majority of incident light may refer to at least 50% of incident light with reference to light intensity. In some examples, plurality of tapered protrusions 30 may redirect at least 60%, such as, at least 70%, at least 80%, at least 90%, or at least 95% of incident light in such a manner. However, other portions of light may be redirected by light management layer 20 back into lightguide 14. Some of this light may be “recycled” in the sense that the light may be reflected by reflector 16 back into lightguide 14 and light management layer 20.

Moreover, plurality of tapered protrusions 30 may reduce divergence of light incident with respect to the lightguide surface in at least one direction, such as, two directions (e.g., two mutually orthogonal directions). Reducing the divergence of light in such a manner may refer to the reduction of divergence of greater than 50% of incident light, with regard to light intensity, such as, e.g., at least 60% at least 70%, at least 80%, at least 90%, or at least 95%, from lightguide 14.

In some examples, the extent that protrusions 30 redirect incident light depends on the incidence angle. For example, rays incident at polar angles (measured from the surface normal) less than 34 degrees are refracted to polar angles greater than 36 degrees (for refractive index of about 1.5 and apex angle of about 66.6 degrees of protrusions 30). In such cases, if may be preferable for a majority of light output to exhibit a polar angle range greater than approximately 34 degrees. In some examples, assembly 10 may be configured such that the majority of light incident to respective protrusions from the lightguide 14 exhibits an angle with respect to display normal that is greater than approximately 34 degrees. In some examples, lightguide 14 may be configured such that, with reference to light intensity, the at least 50%, such as, e.g., at least 60%at least 70%, at least 80%, at least 90%, or at least 95% of incident light from lightguide 14 exhibits an angle with respect to display normal (substantially orthogonal to surface 22 of display 18) that is greater than approximately 34 degrees, such as, e.g., greater than approximately 45 degrees or greater than approximately 60 degrees.

Of the light transmitted into reflective polarizer layer 24 from plurality of tapered protrusions 30, a portion may transmitted through reflective polarizer layer 24 into LCD 18, while light of a different polarization may be reflected back into lightguide 14 by reflective polarizer layer 24. In general, the polarization of the light reflected back into lightguide 14 by reflective polarizer layer 24 is such that the light would be absorbed by a rear polarizer of LCD 18. Instead, in some examples, this reflected light may be “recycled” in the sense that the light may be reflected by reflector 16 back into lightguide 14 and light management layer 20. The light passing through reflective polarizer layer 24 may be transmitted from light management film 20 into LCD 18 to illuminate outer display surface 22.

Lightguide 14 of backlit display device 10 may be any suitable lightguide known in the art and may include one or more of the example lightguides described in U.S. Pat. Nos. 6,002,829 to Winston et al. dated Dec. 14, 1999, and 7,833,621 to Jones et al. dated Nov. 16, 2010. The entire content of each of these U.S. are incorporated by reference herein. Suitable materials for reflector 16 adjacent to lightguide 14 may include Enhanced Specular Reflector (available commercially from 3M, St. Paul, Minn.), or a white PET-based reflector.

The material and construction of reflective polarizer layer 24 may be selected such that reflective polarizer layer 24 reflects light of a particular polarization state while transmitting light of another polarization state. For example, reflective polarizer layer 24 may have relatively low reflectively for light parallel to the pass axis of reflective polarizer layer 24 and relatively high reflectivity for light perpendicular to the pass axis of reflective polarizer layer 24. As described above, reflective polarizer layer 24 may be selected to exhibit a relatively high reflectivity for light that would generally be absorbed by a rear polarizer of LCD 18, allowing that light instead to be reflected back into lightguide 14 and potentially recycled. Suitable materials for reflective polarizer layer 24 may include Dual Brightness Enhancement Film or “DBEF” (available commercially from 3M, St. Paul, Minn.). In some examples, reflective polarizer layer 24 may include multiple thin film layers having different optical properties.

As shown, plurality of tapered protrusions 30 are disposed on reflective polarizer layer 24 and positioned between reflective polarizer layer 24 and lightguide 14. Plurality of tapered protrusions 30 may include substantially pyramidal shaped protrusions with at least four side faces and/or substantially conical shaped protrusions. Regardless of the shape, each protrusion of plurality of tapered protrusions 30 tapers toward lightguide 14, and tapers away from LCD 18 and reflective polarizer layer 24.

As shown by the combination of FIGS. 1A and 1B, the shape of plurality of protrusions 30 is such that each individual protrusion tapers toward lightguide 14 along two substantially orthogonal planes. For example, the sides of protrusion 30A taper toward each other in the direction of lightguide 14 for a cross section of protrusion 30A taken along the x-z plane as well as the x-y plane. Unlike that of linear prisms, each protrusion of plurality of protrusions 30 taper in this fashion in along substantially all planes substantially parallel to the x-axis, as oriented in FIGS. 1A and 1B. While linear prisms may redirect/reroute light from lightguide 14, to redistribute at least a portion of the light toward LCD 18 within the x-z plane, plurality of protrusions 30 may redirect/reroute light from light guide 14, to redistribute at least a portion of the light toward LCD 18 within both the x-z and x-y planes. In some examples, plurality of tapered protrusions 30 may redirect light incident with respect to the lightguide surface of protrusions 30 such that for incident light propagating along a first direction, the protrusions redirects the majority of incident light along a second direction different than the first direction passing through plurality of tapered protrusions. Protrusions 30 may redirect/reroute at least a majority of such light from light guide 14 within both the x-z and x-y planes. Moreover, plurality of tapered protrusions 30 may reduce divergence of light incident with respect to the lightguide surface in at least one direction.

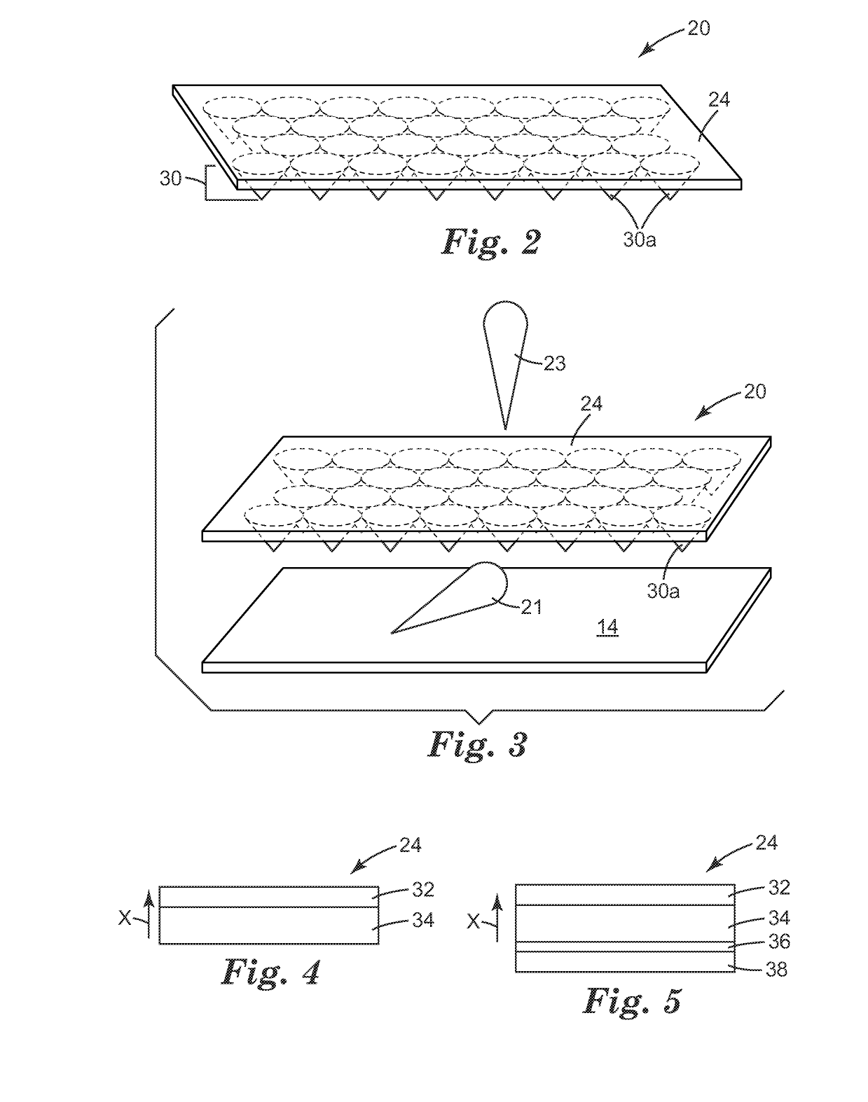

FIG. 2 is a conceptual diagram illustrating example light management film 20 of FIGS. 1A and 1B. As shown, light management film 20 includes reflective polarizer layer 24 and plurality of tapered protrusions 30 disposed thereon. Plurality of tapered protrusions 30 are arranged in a single layer on the bottom surface of reflective polarizer layer 24. Plurality of tapered protrusions 30 extend out of the bottom surface of reflective polarizer layer 24 and taper away from layer 24. Plurality of protrusions 30 may have a substantially homogeneous construction, e.g., all protrusions within redirecting layer 26 are similarly sized and shaped, or the size and shape of the protrusions in redirecting layer 26 may vary substantially continuously or, alternatively, non-continuously, throughout redirecting layer 26.

Tapered protrusions 30 may be arranged in any suitable pattern. In the example shown in FIG. 2, plurality of tapered protrusions 30 are generally arranged in a series of rows and columns in substantially a hexagonal close packed (HCP) pattern. While the base of tapered protrusions are shown as circular, in some examples, the base of protrusions 30 may have a hexagonal shape. Another example HCP structure is shown in FIG. 22. In other examples, plurality of tapered intrusions 30 may be arranged as a square grid pattern.

Gaps between the bases of adjacent tapered protrusions 30 may result in leakage through redirecting layer 26, which can influence the performance of light management film 20. In general, the gaps between the bases of adjacent tapered protrusions may be flat, inactive areas that result in such leakage. As such, in some examples, tapered protrusions 30 may be arranged in a manner that reduces such gaps between adjacent tapered protrusions 30. In some examples, plurality of protrusions 30 may be arranged such that there are substantially no gaps between the bases of adjacent protrusions 30, e.g., as may be the case for an HCP arrangement in which protrusions 30 have a hexagonal base. In some examples, interfaces between the bases of neighboring protrusions may have substantial portions in contact with each other. In some examples, substantial portions may include to at least 50%, such as, e.g., at least 60% or at least 70% in contact with each other.

The areal density of tapered protrusions 30 disposed on reflective polarizer layer 24 may also influence the properties of light management film 20. In general, the density of tapered protrusions 30 relative the surface area of reflective polarizer layer 24 may be expressed in terms of the fraction of the surface area covered by protrusions 30. For protrusions with a hexagonal base in an ideal HCP arrangement, the fraction is approximately 100%, as is the case for protrusions with a square base in a square grid. For circular base protrusions, in a square array the fraction is approximately 78.5% (=π/4) and in a HCP arrangement the fraction is approximately 90.7% (=π/2√3).

Any suitable material may be used to form plurality of tapered protrusions 30. As described above, the shape and materials of plurality of tapered protrusions 30 may allow at least a portion of light from lightguide 14 passing through redirecting layer 26 to reduce the divergence of incident light and redirect a majority of incident light propagating along a first direction to a second direction different from the first direction. Suitable materials may include optical polymers such as acrylates, polycarbonate, polystyrene, styrene acrylo nitrile, and the like. Suitable materials ma include those materials used to form Brightness Enhancing Film or “BEF” (commercially available from 3M, St. Paul, Minn.). In some examples, the material used to form plurality of tapered protrusions 30 may have the refractive index between approximately 1.4 and approximately 1.7, such as, e.g., between approximately 1.45 and approximately 1.6. However, in some cases, the shape of protrusions 30 of redirecting layer 26 may allow the properties of the redirecting layer 26 to be relatively independent of the refractive index of the material used to form protrusions 30.

FIG. 3 is a conceptual diagram illustrating an exploded view of example light management film 20 and example lightguide 14. As described above with regard to FIGS. 1A and 1B, light 21 emitted from lightguide 14 into light management film 20 may be redirected and/or collimated to some extent when passing through redirecting layer 26. In the example shown in FIG. 3, light 21 is redirected in a direction substantially orthogonal to the upper surface of light management film 20 as light 23. Light 23 may enter LCD 18 and illuminate outer display surface 22 (FIGS. 1A and 1B).

The shape of plurality of protrusions 30 may influence the redirection of light passing through light management film 20. As previously described, the shape of protrusions 30 as substantially conical shaped protrusions and/or substantially pyramidal shaped protrusions with at least four faces may allows redirecting layer 26 to redirect light incident with respect to the lightguide surface of protrusions 30 such that for incident light propagating along a first direction, protrusions 30 redirect the majority of incident light along a second direction different than the first direction passing through plurality of tapered protrusions. Additionally, protrusions 30 may reduce the divergence of incident light passing through redirecting layer 26 from lightguide 14. In some examples, referring to the azimuthal direction about perpendicular to the base plane of protrusions 30, and a “polar” angle measured from the perpendicular, the redirection toward the normal may be fairly insensitive to the azimuthal angle of the light from the lightguide if protrusions 30 have a sufficient number of sides (such as, e.g., greater than 10), and the peak polar incident angle matches the protrusion apex angle that allows reflection toward the normal. The redirection of light from lightguide 14 may be accomplished with only a single layer of tapered protrusions 30 as compared to, e.g., an example in which two linear prism films are stacked in a crossed configuration redirect light from a lightguide.

FIGS. 4 and 5 are conceptual diagrams illustrating two different examples of reflective polarizer layer 24 of example light management film 20. In the example of FIG. 4, layer 24 includes two sub-layers. In particular, reflective polarizer layer 24 includes matter coating 32 on top of reflective polarizer sub-layer 34. Conversely, in the example of FIG. 5, reflective polarizer layer 24 includes matte coating 32, reflective polarizer sub-layer 34, adhesive sub-layer 36, and clear film sub-layer 38, in that order from top to bottom.

Suitable materials and construction of reflective polarizer sub-layer 34 may be substantially similar to that described above with regard to reflective polarizer layer 24 (FIGS. 1A and 1B). In general, reflective polarizer sub-layer 34 may reflect or transmit light from lightguide 14 and redirecting layer 26 based on the polarization state of the light.

Matte coating 32 may act to reduce resolution of undesired visual artifacts for light transmitted through reflective polarizer sub-layer 34 due to, e.g., defects in lightguide 14 or bright regions near light source 12. In some examples, matte coating 32 may have a thickness between approximately 3 micrometers and approximately 100 micrometers and may be uniform or non-uniform in thickness over surface of reflective polarizer sub-layer 34. Matte coating 32 may diffuse light to hide defects or improve spatial uniformity, as stated above. It may also provide some degree of collimation of outgoing light, and some degree of gain in the axial direction via angle recycling. Polystyrene or glass beads of one index may be mixed with a clear binder of another index, such as an acrylates, to create such a bead coating, or these components may have the same index if the coating results in surface protrusions. Such a matte coating may also be micro-replicated from a mold, using heat or UV curable clear polymers.

In the example of FIG. 5, clear film sub-layer 38 is bonded to reflective polarizer sub-layer 34 via adhesive sub-layer 36. Clear film sub-layer 38 may provide additional stiffness to the full film assembly to reduce warp and curl in films, and may have a thickness between approximately 10 micrometers and approximately 200 micrometers. Suitable materials for clear film sub-layer 38 may include PET, acrylic, poly carbonate, and the like. Adhesive sub-layer 36 used to bond clear film 38 to reflective polarizer sub-layer 34 may be clear or diffusive. Example materials for adhesive sub-layer 36 may include optically clear pressure sensitive adhesive, acrylates, urethane acrylates or any optically clear adhesive material.

In the configuration shown in FIGS. 4 and 5, matte coating 32 may be positioned between reflective polarizer sub-layer 34 and LCD 18 (FIGS. 1A and 1B). Although not shown, plurality of protrusions 30 may be disposed on (directly or indirectly) the bottom surface of reflective polarizer layer 24. In some examples, reflective polarizer layer 24 may serve as a substrate for protrusions 30 to form plurality of protrusions 30. The configurations of reflective polarizer layer 24 in FIGS. 4 and 5 are merely exemplary, and other configurations are contemplated. In some examples, reflective polarizer layer 24 may not include matte coating 32 and/or clear film sub-layer 38. Additionally or alternatively, light management film 20 may include one or more diffusive layers, e.g., to reduce the resolution of undesired visual artifacts due to, e.g., lightguide defects or bright regions near light source 12. In some examples, a prism structure or an asymmetrically scattering diffuser structure may be substituted for the matte coating. All such structures may provide angle management of light above the reflective polarizer.

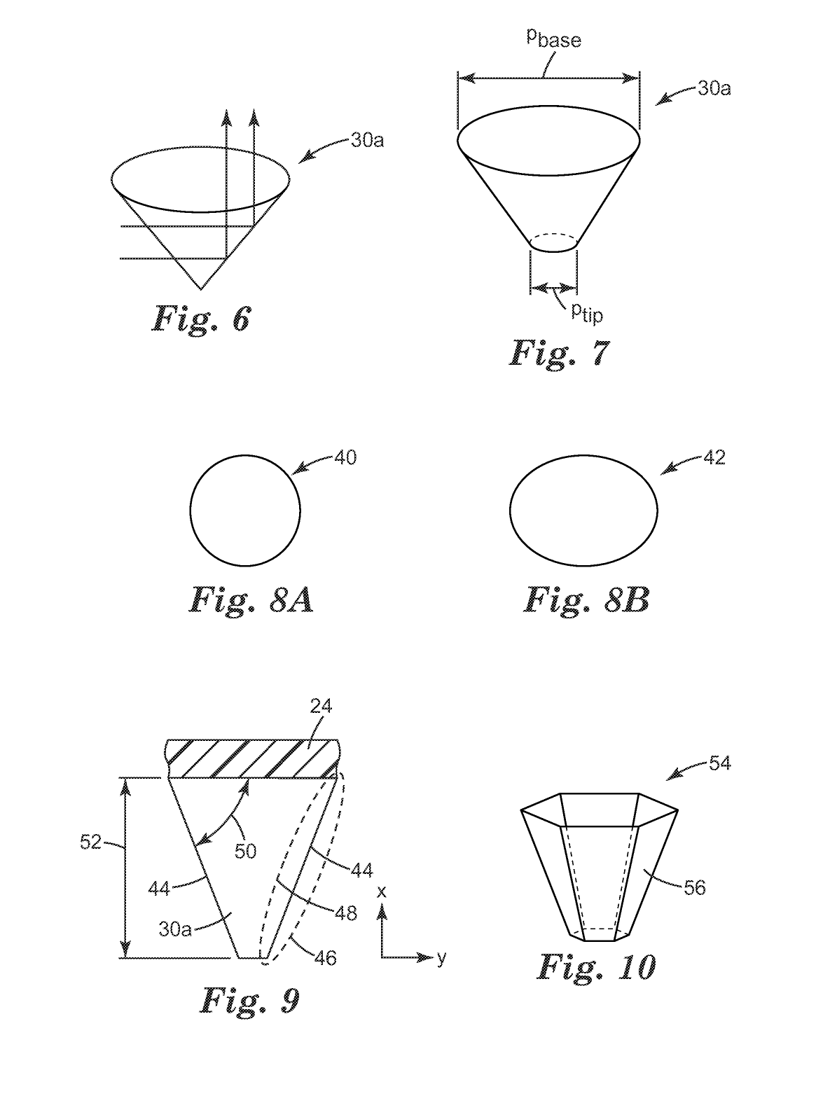

FIGS. 6 and 7 are conceptual diagrams illustrating two different example tapered protrusions 30A. As described above, in some examples, all or some of plurality of tapered protrusions 30 may have a substantially conical shape. FIGS. 6 and 7 illustrate two example tapered protrusion 30A that may be characterized as substantially conical shaped protrusions. In each case, protrusion 30A has substantially circular base with a continuously curved side surface (e.g., as opposed to a pyramidal shaped protrusions with multiple discrete side faces forming axially extending edges on the outer surface) that tapers in when moving away from the base of protrusion. As described above, unlike linear prisms, the substantially conical shape of tapered protrusion 30A is such that outer surface of protrusions 30A tapers in substantially all planes substantially parallel to the x-axis, as indicated in FIG. 1A and 1B.

In some examples, including that shown in FIG. 6, tapered protrusion 30A has a substantially conical shape in which the tapered sides terminate at substantially the same point to form a “sharp tip”. In other examples, including that shown in FIG. 7, tapered protrusion 30A has a substantially conical shape without a sharp tip. In such case, the substantially conical shaped protrusion may be essentially a sharp tipped conical protrusion with a portion of the tip removed. In the example of FIG. 7, the base diameter of protrusion 30A (labeled P_{base}) is greater than the tip diameter (labeled Pₜᵢₚ) due in part to the tapered shape.

While the example of FIG. 7 shows the top of tapered protrusion 30A as a planar surface substantially parallel to the base surface, other configurations are contemplated. For example, the top surface of tapered protrusion 30A in FIG. 7 may be non-planar, e.g., convex, and/or may be canted relative to the base surface. A convex tip surface may be referred as a “rounded” tip. Truncation or rounding of the tip may be beneficial to improve robustness of the film and to mitigate potential breakage of the tip portion during assembly and use of light management film 20, for example, in display device 10. For a fixed tip radius, it may also be beneficial to maximize the base radius (cone spacing) to minimize the effects of tip truncation or rounding.

In some examples, the tip of tapered protrusion 30A may be reasonably sharp to redirect the maximum amount of light toward the axial direction (x-direction in FIGS. 1A and 1B). For example, in some cases, the axial luminance of light management film 20 decreases with the relative area of the tip and base regions of protrusions 30. In the case of tapered protrusion 30A shown in FIG. 7, it may be preferred that the tip area be less than about 20%, such as, e.g., less than about 10 percent of the base area to reduce light loss.

As shown in FIG. 6, example protrusion 30A as well as other example protrusions described herein may redirect light incident with respect to the lightguide surface of protrusions 30 such that for incident light propagating along a first direction, the protrusions 30 redirect the majority of incident light along a second direction different than the first direction passing through plurality of tapered protrusions. Moreover, protrusions 30 may reduce divergence of light incident surfaces of respective protrusions in at least one direction (e.g., two mutually orthogonal directions). Protrusion 30A may redirect/reroute light in such a manner in both the cross guide and down guide direction when incorporated into display 10, for example.

FIGS. 8A and 8B are conceptual diagrams illustrating horizontal cross-sections of two different example tapered protrusions 40 and 42, respectively. Tapered protrusions 40 and 42 may be examples of protrusions of light management film 20. For reference, views shown in FIGS. 8A and 8B may be taken along a cross-section substantially parallel the z-y plane shown in FIGS. 1A and 1B. The example cross-sections may be representative of the base of example protrusions 40 and 42 or other points on protrusions 40 and 42 moving axially.

As shown in FIG. 8A, protrusion 40 has a substantially circular cross-section. Conversely, as shown in FIG. 8B, protrusion 42 has an elongated cross-section in the shape of an ellipse or oval. Protrusion 42 with an elongated cross-section may provide for different properties when employed in light management film 20 compared to that of protrusion 40 with a circular cross-section, for example. In some examples, for films employing a plurality of protrusion 42, protrusion 42 may be elongated in the down guide direction or the cross guide direction. As will be described below, in some examples, axial output may be increased when protrusions with elongated cross-sections, such as protrusion 42, are oriented with the elongated axis in the cross-guide direction. In some examples, narrowing the protrusion cross section across the lightguide (elongating down-guide) may have the benefit of narrowing and concentrating the angular range of light exiting the protrusion, which can help increase the axial luminance In some examples, protrusions may have aspects ratios between approximately 0.5 and approximately 2.0, such as, e.g., between approximately 0.8 and approximately 1.2.

FIG. 9 is a conceptual diagram illustrating a cross-section of tapered protrusion 30A on reflective polarizer layer 24. For reference, the view shown in FIG. 9 may be taken along a cross-section bisecting protrusion 30A in the x-y plane. More generally, due to the shape of protrusion 30A, the view of FIG. 9 may also be representative of a cross-section bisecting protrusion 30A in any plane parallel to the x-direction. As described above, protrusion 30 may have a substantially conical shape or a substantially pyramidal shape with at least four side faces. Although not shown in FIG. 9, regardless of the shape of protrusion 30A, protrusion 30A may taper away from reflective polarizer layer 24 and may taper towards lightguide 14 when employed in display device 10 (FIG. 1A and 1B).

As shown in FIG. 9, protrusion 30A protrudes from the surface of reflective polarizer layer 24, and has a height 52. The height 52 of protrusion 30A may be in the range of approximately 10 micrometers to approximately 200 micrometers (such as, e.g., between approximately 20 micrometers to approximately 180 micrometers, more preferably, about 75 micrometers to about 150 micrometers). In some examples, protrusion 30A may have a height of at least approximately 10 micrometers. The height of protrusion 30A may define the thickness in the x-direction. More generally, the thickness of light management layer 20 (shown in FIGS. 1A and 1B, for example), which includes plurality of protrusions 30 and reflective polarizer layer 24, may be between approximately 35 micrometers and approximately 500 micrometers, such as, e.g., between approximately 50 micrometers and approximately 200 micrometers.

Side wall 44 tapers of protrusion 30A tapers in moving axially (in the negative x direction). Side wall 44 defines an angle 50 relative to the base plane of protrusion 30A. In general, angle 50 is defined such that protrusion 30A tapers moving away from surface of reflective polarizer layer 24 and toward light guide 14 (FIGS. 1A and 1B). Angle 50 may be substantially constant moving radially around the vertical axis (x-direction) of protrusion 30A. In such examples, protrusion 30A may be substantially symmetric about the vertical axis. In some examples, axial symmetry of protrusion 30A may allow for conversion of light from lightguide 14 at a desired bias to provide for relatively high yields. In other examples, protrusion 30A may be asymmetrical about the vertical axis, in which case, angle 50 may vary moving radially around the vertical axis. In such cases, protrusion 30A may be viewed as being tilted in one direction. For instances in which protrusion 30A is axially symmetric, angle 50 may be less than 90 degrees, or more particularly, less than approximately 50 degrees.

In some examples, protrusion geometry may be defined by the height, base and based aspect ratio, cone tilt, and apex angle. In some examples, protrusion 30A may define a tilt within +/− approximately 10 degrees, and the cone apex angle may be between approximately 50 to approximately 80 degrees. As noted above, in some examples, protrusion 30A may have a height between approximately 10 micrometers to approximately 200 micrometers, and an aspect ratio between approximately 0.5 to approximately 2.0.

In the example shown in FIG. 9, side wall 44 of protrusion 30A is a substantially planar surface. In other examples, protrusion 30A may have a convex side wall 46 or a concave side wall 48. Further, while side wall 44 of protrusion 44 is shown in FIG. 9 as a substantially smooth surface, in other examples all or a portion of side wall 44 may include one or more three-dimensional feature on the surface (projections, depressions, grooves and the like) that provide for a rough or non-smooth surface). In some examples, the surface features of side wall 44 may be configured such that protrusion 30A exhibits a surface roughness between approximately 0.1 micrometers root mean square (rms) and approximately 5 micrometers root mean square (rms), such as, e.g., between approximately 0.2 micrometers (rms) and approximately 3 micrometers root mean square (rms). In some examples, protrusion 30A exhibits an average surface roughness less than the wavelength of visible light, such as, e.g., less than about 90 percent of the wavelength of visible light, less than about 50 percent of the wavelength of visible light, or less than 10 percent of the wavelength of visible light. In some examples, the surface of protrusion 30A may be optically smooth. In some examples, concave, convex, or finely structured (rough) surfaces may generally broaden the angular output distribution from the film. This may also aid with improving spatial uniformity of the backlight. In some examples, as the roughness of the surface of protrusion 30A increases, the amount of light redirected in axial direction may be reduced, thereby reducing the brightness of a display.

As described above, protrusion 30A may be representative of one or more of plurality of tapered protrusions 30 that may be disposed on layer 24. In some examples, plurality of protrusions 30 may have a substantially homogeneous construction, i.e., all protrusions are similarly sized and shaped, or the size and shape of plurality of protrusions may vary substantially continuously or, alternatively, non-continuously, throughout a redirecting layer 26.

Although examples of the disclosure have been illustrated primarily with protrusion 30A being substantially conical shaped, protrusion 30A and, more generally, plurality of protrusions 30 may be substantially pyramidal shaped protrusions including at least four side faces. In general, all of the description in this disclosure with regard to features of substantially conical shaped protrusions (e.g., height, tip construction, side wall angles, side wall shape, and the like) also applies to substantially pyramidal shaped protrusions with at least four side faces, and vice versa.

FIG. 10 is a conceptual diagram illustrating example tapered protrusion 54. As shown, protrusion 54 has a substantially pyramidal shaped rather than a substantially conical shape. Protrusion 54 is an example of a protrusion that may be disposed on reflective polarizer layer 24 (FIG. 1A and 1B). When employed in display device 10, protrusion 54 may taper toward lightguide 14 and away from redirecting layer 24.

In the example shown in FIG. 10, protrusion 54 includes six side faces 56 (only one side face is labeled for ease of illustration). Unlike that of substantially conical shaped protrusion 30A shown in FIG. 7, for example, protrusion 54 has discrete side faces 56, and edges are formed at the intersection of respective side faces 56. These discrete side faces 56 taper towards each other moving away from the base of protrusion 54.

As described above, tapered protrusion 54 may include at least four side faces 56. In some examples, tapered protrusion 54 may include greater than three sides faces and less than 11 side faces, such as, e.g., greater than four side face and less than 11 side faces or greater than five side face and less than 11 side faces, although other number of side faces are contemplated. As the number of side face 56 approaches infinity, protrusions 54 may have a substantially conical shape rather than a substantially pyramidal shape.

Any suitable technique may be utilized to fabricate examples of the disclosure. Example manufacturing techniques for fabricating a redirecting layer including a plurality of tapered protrusions (e.g., redirecting layer 26) include embossing, extrusion replication, UV cured molding, and compression molding Molds for the replication process can be created by indention, laser ablation, lithography and chemical etching, or by diamond turning.

### EXAMPLES

A series of experiments were carried out to evaluate the properties and performance of films in accordance with some embodiments of the disclosure. While the following examples are illustrative of one or more embodiments of the disclosure, the examples do not limit the scope of the disclosure.

### Example A

An example light management film in accordance with one example of the disclosure was simulated for testing. The simulated film included a reflective polarizer layer and a plurality of protrusions disposed thereon, and tapering away from the reflective polarizer layer. The plurality of protrusions were simulated for Example A, as well as the other simulations described below, to be provided in a square arrange and have a substantially circular base. A ray trace program was then used to evaluate the film using a conoscopic output given a defined input. Suitable ray trace programs for such a simulation may include commercially available programs, such as TracePro from Lambda Research, ASAP from BRO, and Light Tools from ORA.

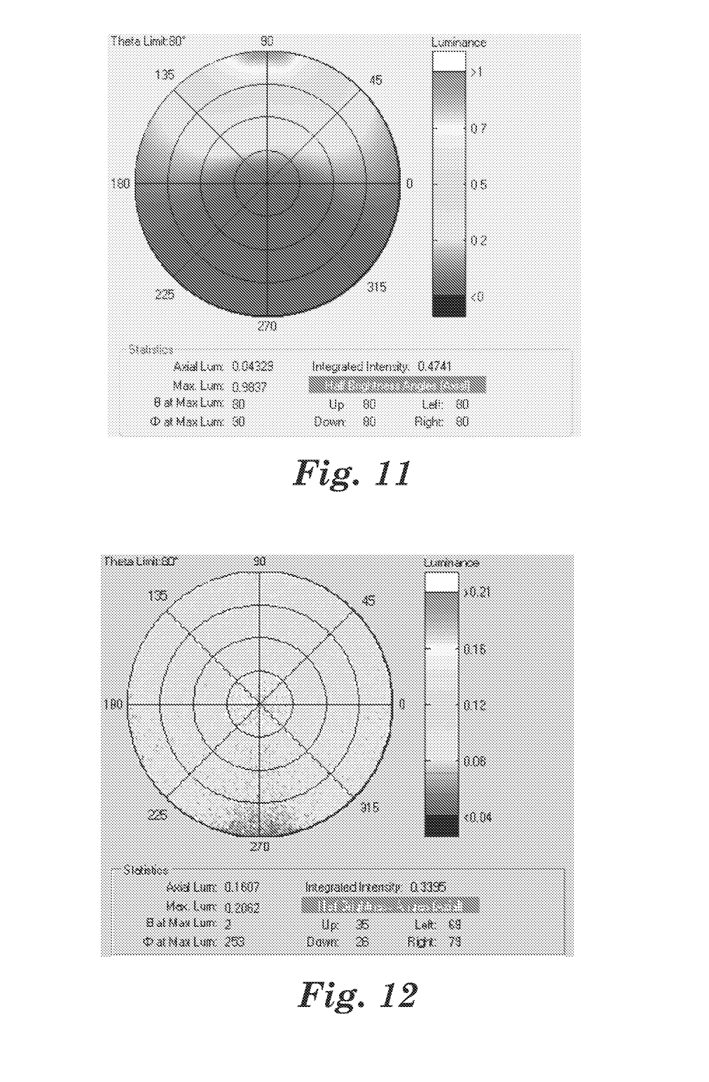

FIG. 11 is an image showing a simulation of the conoscopic input of the example lightguide, which corresponds to the input from the lightguide into the simulated example light management film. FIG. 12 is an image showing the conoscopic output from the example light management film, as simulated by a ray tracing program. As shown by a comparison of the two conoscopic images, the conoscopic output shows how the simulated film redirects light from the lightguide from high angles towards angles centered about the film perpendicular.

### Example B

A variety of example light management films in accordance with one example of the disclosure were simulated. Each of the example simulated films was substantially similar to each other. For example, each example light management film was simulated to include a reflective polarizer layer and a plurality of substantially conical shaped protrusions disposed thereon, and tapering away from the reflective polarizer layer. For each film, the height of the plurality of conical shaped protrusions was substantially uniform throughout, and the conical shaped protrusions were disposed in a square array with fixed distance between each conical shaped protrusion of approximately 24 micrometers (μm) and had a refractive index of approximately 1.565. However, the height of the tapered protrusions for each example light management film was varied from one to another. In particular, the first example film included tapered, substantially conical shaped protrusion having a height of approximately 17 micrometers (m). The second example film included tapered, substantially conical shaped protrusion having a height of approximately 18 μm. The third example film included tapered, substantially conical shaped protrusion having a height of approximately 19 μm. The fourth example film included tapered, substantially conical shaped protrusion having a height of approximately 20 μm.

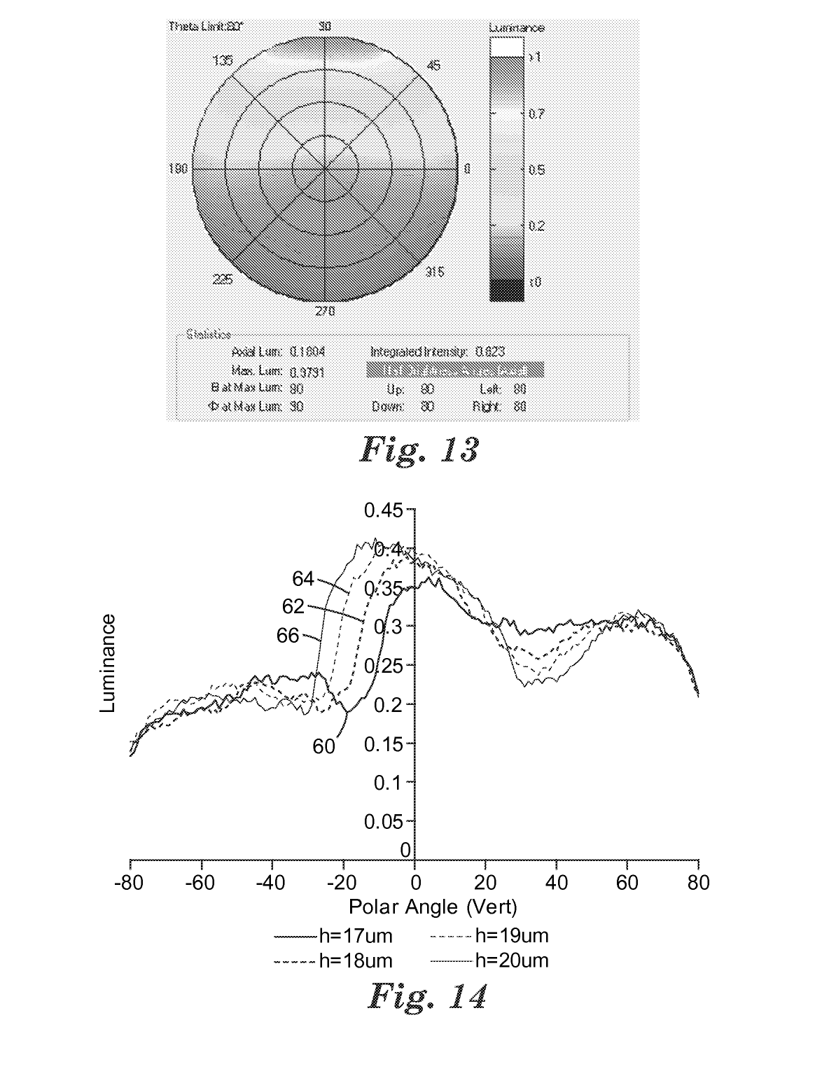

FIG. 13 is an image showing the simulated conoscopic input. FIG. 14 is a plot of luminance versus polar angle along a vertical plane for each of the four example redirecting films. The plot of FIG. 14 was generated based on simulated conoscopic output taken along a vertical cross section (running from 90 degrees to 270 degrees) for each of the four example redirecting film. Line 60 corresponds to the first example film with tapered, substantially conical shaped protrusion having a height of approximately 17 μm. Line 62 corresponds to the second example film with tapered, substantially conical shaped protrusion having a height of approximately 18 μm. Line 64 corresponds to the third example film with tapered, substantially conical shaped protrusion having a height of approximately 19 μm. Line 66 corresponds to the fourth example film with tapered, substantially conical shaped protrusion having a height of approximately 20 μm.

As illustrated by the plot of FIG. 14, the third example film (protrusion height of 19 μm) may provide the maximum axial luminance and best center output distribution (approximately 0 degrees) about the axial direction among the four example films. The plot of FIG. 12 includes a lobe evident at or near 60 degrees, and may be due to light leakage between respective cones in square arrays used for each example redirecting film. In some cases, such light leakage may be reduced or eliminated by using a different protrusion arrangement, such as, e.g., a hexagonally close packing arrangement.

### Example C

In another example, two example light management films were simulated. The example light management films were substantially similar to each other for the simulation. For example, each example light management film was simulated to include a reflective polarizer layer and a plurality of substantially conical shaped protrusions disposed thereon, and tapering away from the reflective polarizer layer.

However, the tapered protrusions of the first example film were formed with a clear polymer material having a refractive index, n, of approximately 1.565. Conversely, the tapered protrusions of the first example film were formed with a clear polymer material having a refractive index, n, of approximately 1.65.

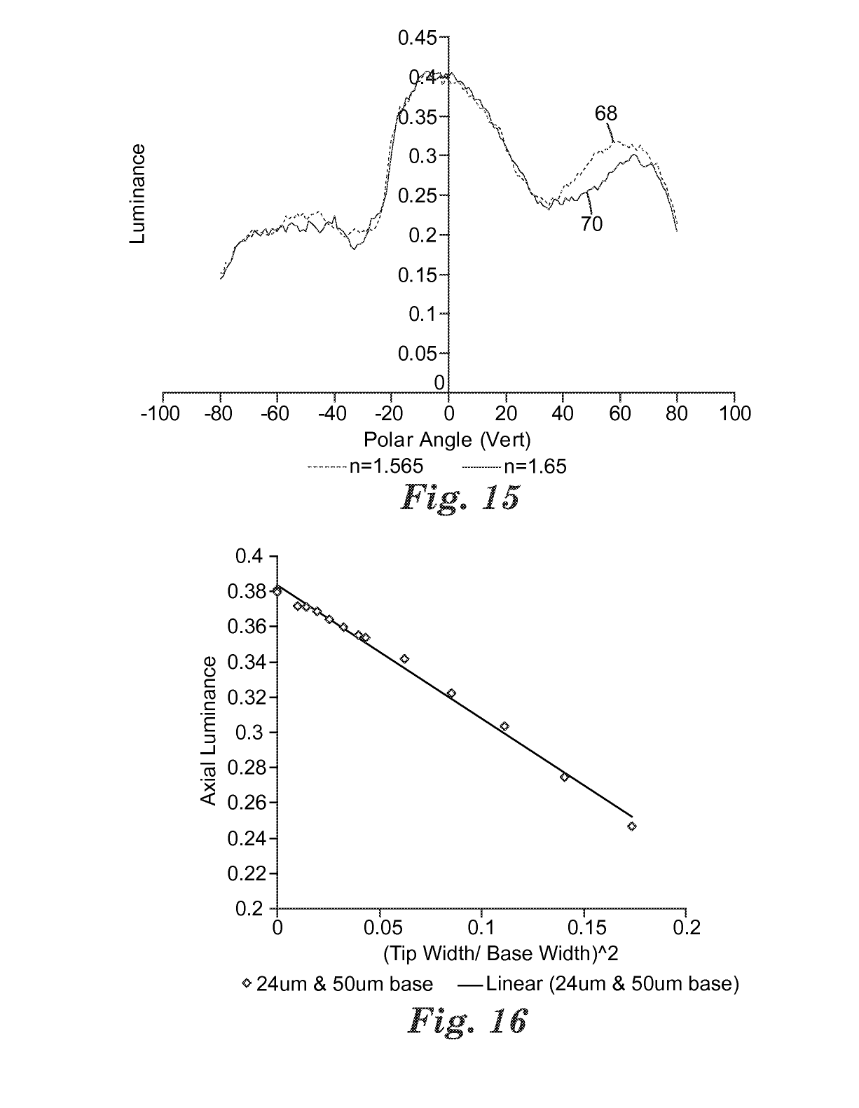

FIG. 15 is a plot of luminance versus polar angle along a vertical plane for both of the example films. The plot of FIG. 15 was generated based on simulated conoscopic output taken along a vertical cross section (running from 90 degrees to 270 degrees) for both example films. In FIG. 15, line 68 corresponds to the first example film with tapered, substantially conical shaped protrusion formed with a clear polymer material having a refractive index of approximately 1.565, and line 70 corresponds to the second example film with tapered, substantially conical shaped protrusion formed with a clear polymer material having a refractive index of approximately 1.65.

As shown by the plot of FIG. 15, in some examples, the output distribution for example redirecting films of the disclosure may be relatively insensitive to the refractive index of the material used to form the protrusions in a redirecting film. It is noted that the difference in luminance between about 40 degrees and 60 degrees for each example film may be due to cone refraction.

### Example D

In another example, two example light management films were simulated. The example light management films were substantially similar to each other for the simulation. For example, each example film was simulated to include a reflective polarizer layer and a plurality of substantially conical shaped protrusions disposed thereon and tapering away from the reflective polarizer layer. Both films where simulated with an array of pyramidal shaped protrusions with 10 facets each, refractive index 1.565, with included angle of 67.4 degrees, and a light source input distribution shown below the plot. However, one film was simulated with a 24 micrometer base diameter and the other was simulated with a 50 micrometer base diameter. For each example diameter, the ratio of tip to base area was varied to determine that influence of tip truncation.

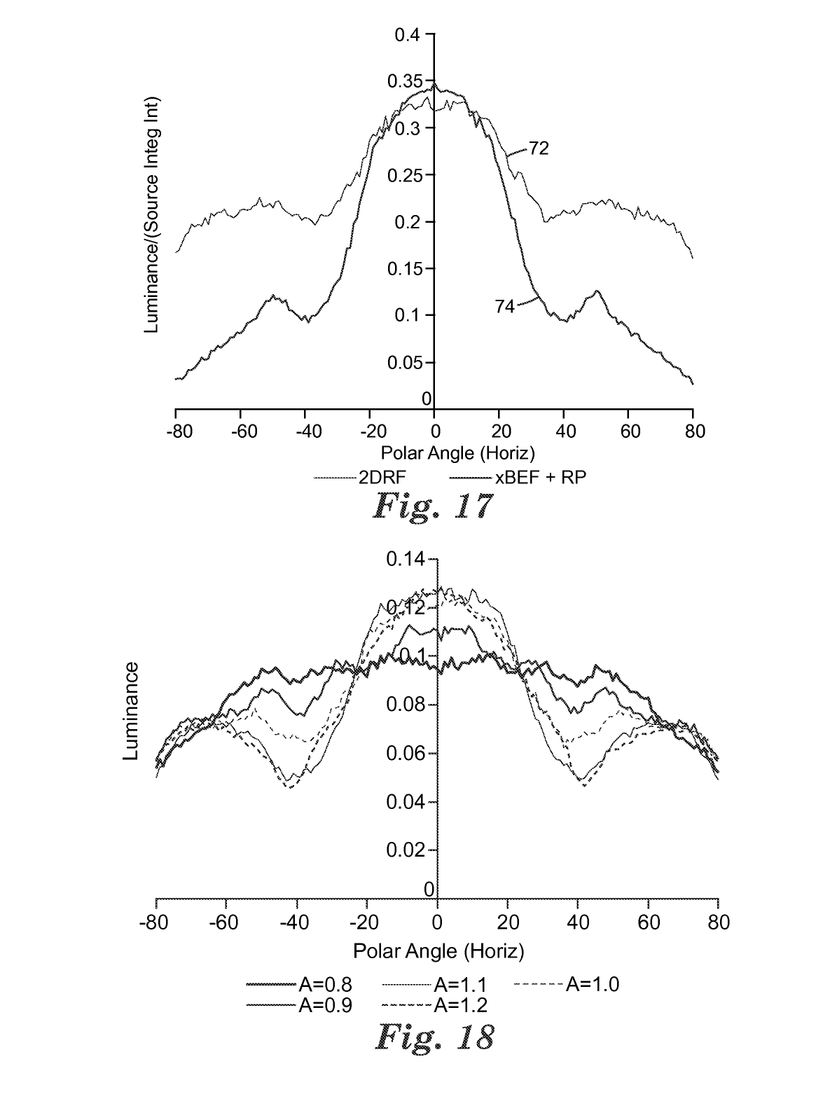

FIG. 16 is a plot of the ratio of tip to base area versus axial luminance The input distribution is the same as that FIG. 13 is an image showing the simulated conoscopic input. As all the points lie on the same line shows that only the ratio of the tip to base areas is needed to predict the effect of tip truncation.

### Example E

In another example, two example light management film stacks were simulated. The first example film stack (referred to a TYPE A) simulated an example film in accordance with one or more examples of the disclosure. In particular, the example film included a reflective polarizer portion substantially similar to that shown in FIG. 5 but without matte layer 32, and a plurality of tapered protrusions tapering away from the reflective polarizer portion. As such, the first example had a configuration of reflective polarizer layer, adhesive layer, clear substrate layer, tapered protrusions, and lightguide, in that order with the tapered protrusion tapering away from the reflective polarizer layer. The tapered protrusions were modeled as an array of 20 sided pyramids with a refractive index of approximately 1.565, an apex angle of approximately 64.5 degrees, and a base diameter of approximately 24 micrometers. The reflective polarizer layer was a simulation of DBEFQ available from 3M, St. Paul, Minn. The polarizer was above the tapered protrusions in the model with the pass axis aligned with that of the reflective polarizer. The input light distribution for the simulation for the TYPE A film is that shown in FIG. 11, corresponding to a lightguide without a diffuser. Such input may be best suited in some cases for films with a plurality of tapered protrusion, and do away with the diffuser film, thereby simplifying the backlight.

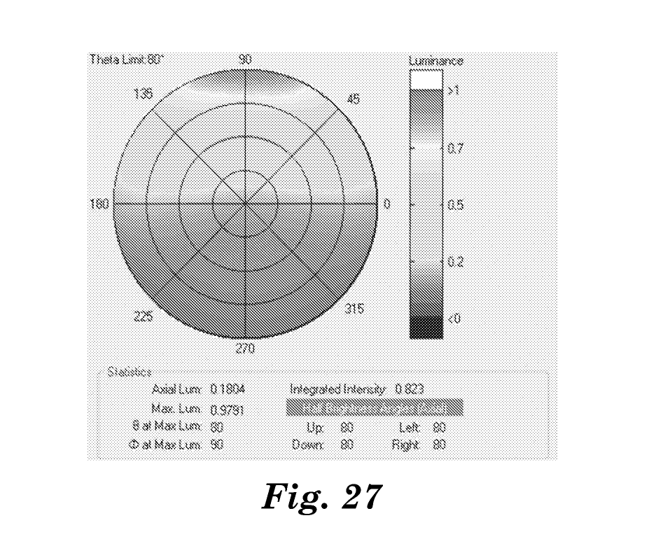

The second example film stack (referred to as TYPE B), in combination with a lightguide, provided for a configuration of reflective polarizer layer, a first prism film, a second prism film, a diffuser layer, and lightguide, in that order. The first and second prism films where formed of a clear substrate topped with a plurality of parallel linear prisms with 90 degree apex angles, and were provided in a crossed orientation relative to each other. The input light distribution for the simulation of the TYPE B film is that shown FIG. 27, corresponding to a lightguide plus diffuser. This is a common input into systems including a reflective polarizer and crossed prism films (such as BEF).

FIG. 17 is a plot of luminance versus polar angle along the horizontal (across the propagation direction of the lightguide) for both of the example film stack configurations. In particular, FIG. 17 shows the cross section of the output angle distribution, along the display horizontal from simulations of two example configurations. In FIG. 17, line 72 corresponds to the TYPE A configuration, and line 74 corresponds to the TYPE B configuration. The TYPE A luminance values are normalized to the integrated intensity from the lightguide, and the TYPE B luminance values are normalized to the integrated intensity of the lightguide+diffuser layer. That is, since the total power from the inputs for the TYPE A and TYPE B configurations were not equal, the simulation results were each normalized to the integrated intensity from each source to compare the relative efficiencies of TYPE A and TYPE configurations.

The plot of FIG. 17 shows a relatively high brightness along the axial direction (polar angle=0) for both the TYPE A and TYPE B configurations. At the higher angles, the TYPE A shows considerably higher brightness than the TYPE B configuration. Such results would correspond to viewer LCD images at higher angles with higher brightness for the TYPE A configuration compared to that of the TYPE B configuration.

### Example F

A variety of example light management films in accordance with one example of the disclosure were simulated. Each of the example films was substantially similar to each other. For example, each example redirecting film included a reflective polarizer layer and a plurality of substantially conical shaped protrusions disposed on and tapering away from the reflective polarizer layer. For each film, the height of the plurality of conical shaped protrusions was substantially uniform throughout.

However, for the simulation, the aspect ratio, as defined by a horizontal cross section of the tapered protrusions, for each example redirecting film was varied. As described above with regard to FIG. 8A and 8B, in some examples, the tapered protrusions of a redirecting layer may have a substantially circular base (aspect ratio of approximately 1) or may be elongated, e.g., in the down-guide or cross-guide direction. For aspect purposes of this example, an aspect ratio greater than one represents elongation of respective protrusion bases in the down-guide direction. Such an elongation effectively narrows the cross-section in the z-y cross-section across the lightguide compared to protrusions having an aspect ratio of approximately 1.0. As noted above, in some examples, narrowing the protrusion cross section across the lightguide (elongating down-guide) may have the benefit of narrowing and concentrating the angular range of light exiting the protrusion, which can help increase the axial luminance Conversely, an aspect ratio less than one represents elongation of respective protrusion bases in the cross-guide direction. Such an elongation effectively widens the cross-section in the z-y cross-section across the lightguide compared to protrusions having an aspect ratio of approximately 1.0.

The first example film included tapered, substantially conical shaped protrusion with an aspect ratio of approximately 0.8. The second example film included tapered, substantially conical shaped protrusion with an aspect ratio of approximately 0.9. The third example film included tapered, substantially conical shaped protrusion with an aspect ratio of approximately 1.0 (substantially circular). The fourth example film included tapered, substantially conical shaped protrusion with an aspect ratio of approximately 1.1. The fifth example film included tapered, substantially conical shaped protrusion with an aspect ratio of approximately 1.2.

FIG. 18 is a plot of luminance versus polar angle for each of five example redirecting films. Line 76 corresponds to the first example film (0.8 aspect ratio), line 78 corresponds to the second example film (0.9), line 80 corresponds to the third example film (1.0), line 82 corresponds to the fourth example film (1.1), and line 84 corresponds to the fifth example film (86).

As shown by the plot of FIG. 18, the fourth and fifth example films (aspect ratios of 1.1 and 1.2, respectively) demonstrated the greatest axial output. Of the two example films, the fourth example (aspect ratio of 1.1) had a broader angle distribution and may be preferable in some display systems over the fifth example film.

### Example G

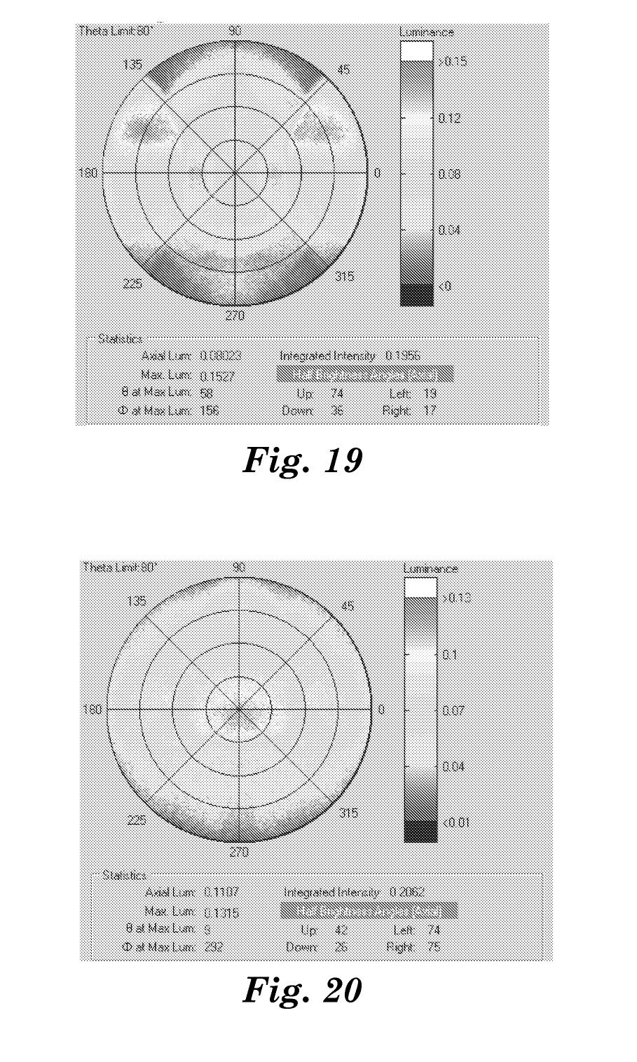

In another example, two example light management films, each including a surface defined by a plurality of substantially pyramidal shaped protrusions, were simulated. The first example film included substantially pyramidal shaped protrusions with four side faces. The second example film included substantially pyramidal shaped protrusions with ten side faces. FIGS. 19 is an image showing the conoscopic output simulated from the light management film including substantially pyramidal shaped protrusion with four side faces. FIGS. 20 is an image showing the conoscopic output simulated from the light management film including substantially pyramidal shaped protrusion with ten side faces.

### Example H

As described above, a variety of techniques may be employed to create example of films described in this disclosure. For example, manufacturing techniques for creating a film with substantially conical or pyramidal shaped protrusions may include embossing, extrusion replication, UV cured molding, and compression molding. Molds for the replication process may be created by indention, laser ablation, lithography and chemical etching, or by diamond turning.

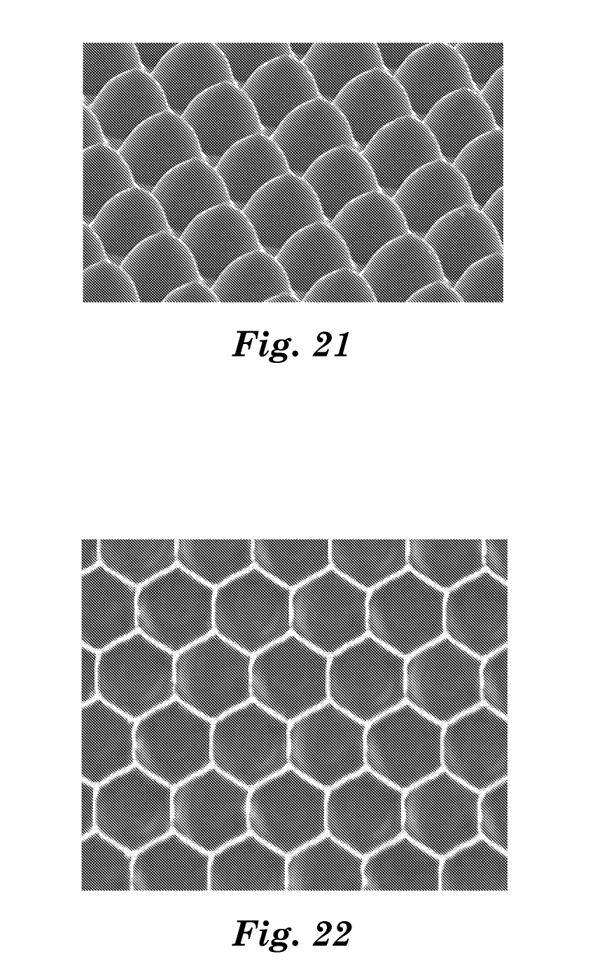

To illustrate one technique, substantially conical shaped protrusion with convex sides (referred in some cases as “bullet” shaped cones) were fabricated by curing a UV resin against a mold consisting of densely packed holes that were created by a laser ablation process. FIG. 21 is a photo optical micrograph illustrating the example “bullet” shaped cones made using the described technique.

### Example I

In another example, a film including an array of conical shaped protrusions was fabricated by replication from a laser ablation mold. FIG. 22 is a photo optical micrograph showing the example array of conical shaped protrusions from a plan view. As shown in FIG. 22, the array of conical shaped protrusions were provided in a hexagonal close packed arrangement. The conical shaped protrusion had a substantially circular base.

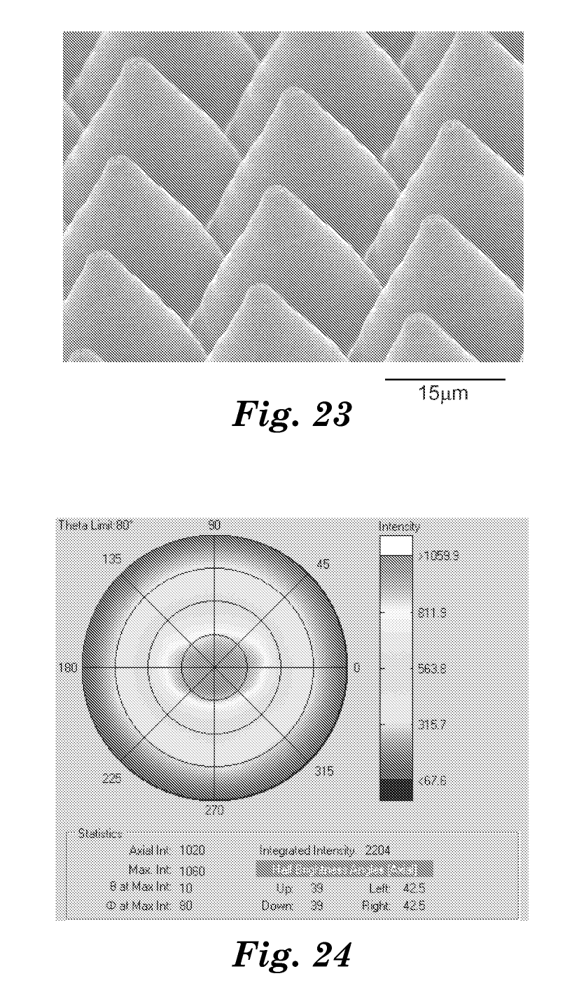

FIG. 23 is a scanning electron microscope (SEM) micrograph showing the array of conical shaped protrusion in FIG. 22 from a perspective view. To evaluate the properties of the example film of FIGS. 22 and 23, the example film was placed on a notebook lightguide, with the cones tapering towards the lightguide. The sample film included a transparent PET substrate, and a plurality of substantially conical shaped protrusions disposed on the surface of the PET substrate. The cone height (peak to valley) was about 20 micrometers, and the diameter of the base of each cone was about 24 micrometers. The cones were provided in a closely packed in hexagonal arrangement. Respective protrusions were formed of an acrylic UV curable resin, with an index of refraction about 1.567 after being cured. The sample film was then place on top of a 3.5 inch diagonal lightguide plate, with 6 LEDs located one edge of the lightguide plate. A specular reflector film (Enhanced Specular Reflector available from 3M, St. Paul, Minn.) was place underneath the lightguide opposite the example film. A conoscope was then place on top of the system, measuring the light distribution output from the flat side of the sample film.

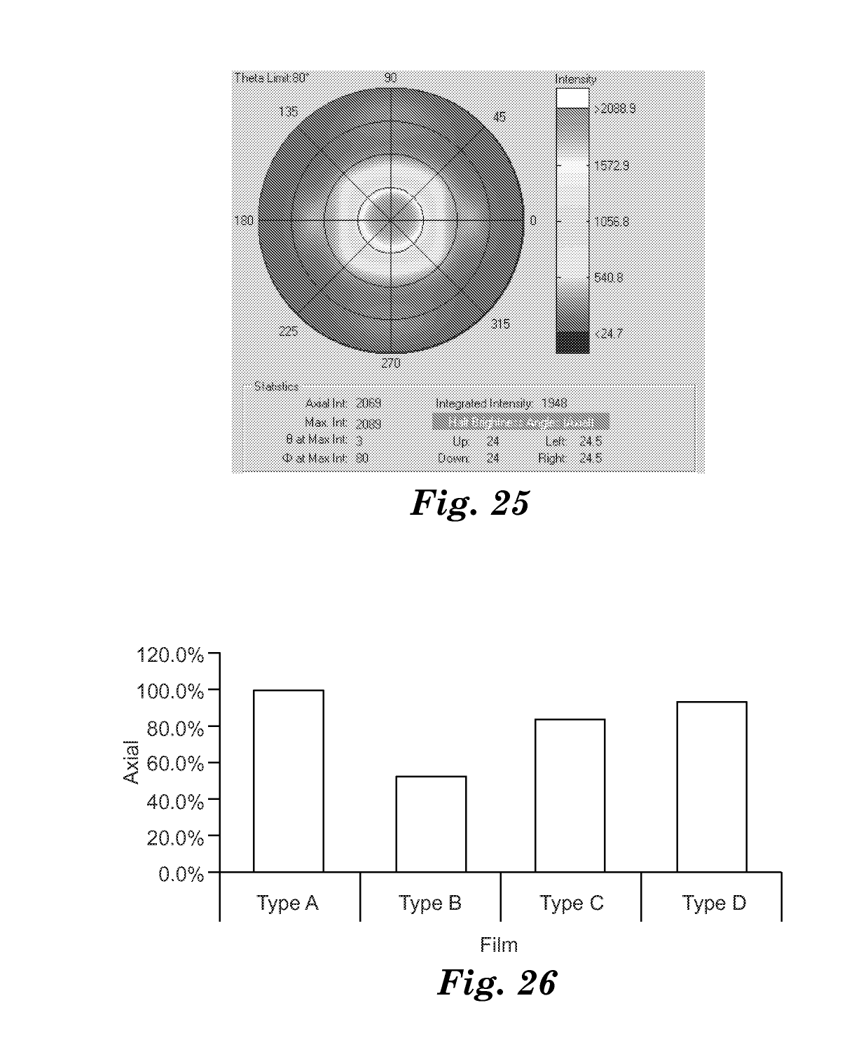

FIG. 24 is a conoscopic image obtained from the combination. As shown in the conoscopic image of FIG. 24, the combination exhibited good collimation in both dimensions.

For comparison, the example film was replaced with an example stack of films including a diffuser layer and two linear prism films stacked in a crossed orientation. The same lightguide and specular reflector film was used. The diffuser film (50 micrometers thick) was placed on top of the light guide plate. Two prismatic films (TBEF2-Tn 90/24 available from 3M, St. Paul, Minn.) were stacked on top of the diffuser film with the prisms of the respective films running perpendicular to each other in a crossed orientation. The prismatic films each had a thickness of approximately 62 micrometers, a prism pitch of approximately 24 micrometers, and the angle of the prisms was approximately 90 degrees. Again, a conoscope was place on top of the system, measuring the light distribution from the top surface of the top prism film.

FIG. 25 is a conoscopic image obtained from the combination. As shown in the conoscopic image of FIG. 25, the combination exhibited a sharper cutoff compared to that of the example redirecting film/lightguide combination.

### Example J

Four example film constructions were fabricated for evaluation. FIG. 26 is a bar graph comparing the axial luminance for the four example film constructions. The first example film (labeled TYPE A) included a bottom diffuser layer and two linear prism films stacked in a crossed orientation, and was substantially the same as the example describe with regard to FIG. 25. The second example film (labeled TYPE B) included a plurality of tapered protrusions, and was substantially the same as the example describe with regard to FIG. 24. The third example film (labeled TYPE C) and fourth example film (labeled TYPE D) both included the same TYPE B film but also included a multilayer reflective polarizer laminated to the sample film. The protrusions tapered away from the reflective polarizer. For the third example, the particular reflective polarizer used was APF type Dual Brightness Enhancing Film (commercially available from 3M, Maplewood, Minn.), which had a thickness of approximately 26 micrometers. For the fourth example, the reflective polarizer was a collimating Dual Brightness Enhancing Film, which is a collimating multi-layer reflective polarizer film. The thickness of the reflective polarizer in the TYPE D example was approximately 56 micrometers. In each example including a tapered protrusions, the tapered protrusions tapered toward the lightguide when measuring the axial luminance summarized in FIG. 26.

As show in the plot of FIG. 26, the use of a reflective polarizer in combination with the plurality of tapered protrusions significantly enhances the axial brightness compared to that of the redirecting film alone. Further, the collimating reflective polarizer appeared to be more effective at increasing axial luminance than the APF. It is believed that further improvements in the tooling and replication processes as well as adjustments to quality and shape of the conical surfaces of the example redirecting layer could increase efficiency to the entitlement levels derived from simulations.

Item 1. A film comprising:

a reflective polarizer layer; and

a plurality of tapered protrusions disposed on and tapering away from the reflective polarizer layer, wherein the plurality of tapered protrusions comprise at least one of a plurality of substantially conical shaped protrusions or a plurality of pyramidal shaped protrusions including at least four side faces.

Item 2. The film of claim 1, wherein the plurality of tapered protrusions comprise a plurality of pyramidal shaped protrusions including between six and ten side faces.
Item 3. The film of claim 1, wherein respective tapered sides of the plurality of tapered protrusions are substantially planar.
Item 4. The film of claim 1, wherein the plurality of tapered protrusions comprise a plurality of tapered protrusions arranged in a hexagonal close packed pattern.
Item 5. The film of claim 4, wherein the plurality of tapered protrusions define a substantially circular base.
Item 6. The film of claim 1, wherein the reflective polarizer layer comprises a matte coating and reflective polarizer sub-layer, wherein the matte coating is disposed on the reflective polarizer sub-layer opposite that of the plurality of tapered protrusions.
Item 7. The film of claim 6, wherein the reflective polarizer layer comprises a clear film sub-layer bonded to the reflective polarizer sub-layer via an adhesive sub-layer.
Item 8. The film of claim 7, wherein the plurality of tapered protrusions are disposed directly on a surface of the clear film sub-layer.
Item 9. The film of claim 1, wherein the plurality of tapered protrusions comprise a plurality of tapered protrusions including one of a substantially circular or substantially elliptical base.
Item 10. The film of claim 1, wherein the plurality of tapered protrusions have a height greater than approximately 10 micrometers.
Item 11. The film of claim 1, wherein the plurality of tapered protrusions define an apex angle between approximately 50 degrees to approximately 80 degrees.
Item 12. The film of claim 1, wherein tapered surfaces of the plurality of tapered protrusion exhibit a surface roughness between approximately 0.1 micrometers root mean squared (rms) and approximately 5 micrometers rms.
Item 13. The film of claim 1, wherein each tapered protrusion of the plurality of tapered protrusions includes a base surface defining a base area and a tip surface defining a tip area, wherein the tip area is less than approximately 10 percent of the base area.
Item 14. The film of claim 1, wherein the plurality of tapered protrusions are disposed directly on the reflective polarizer layer.
Item 15. The film of claim 1, wherein respective base portions of neighboring protrusions are in substantial contact with each other.
Item 16. The film of claim 1, wherein tapered surfaces of the plurality of tapered protrusion exhibit a surface roughness less than approximately a wavelength of visible light.
Item 17. The film of claim 1, wherein the plurality of tapered protrusions reducing a divergence of incident light in at least two mutually orthogonal directions.
Item 18. A display assembly comprising:
a light source;
a lightguide;
an outer display surface; and
a plurality of tapered protrusions between the lightguide and outer display surface, and tapering toward the lightguide, wherein the plurality of tapered protrusions comprise at least one of a plurality of substantially conical protrusions or a plurality of pyramidal-shaped protrusions including at least four faces, wherein light from the light source propagates through the light guide into the plurality of tapered protrusions.
   Item 19. The display assembly of claim 18, wherein the plurality of tapered protrusions comprise a plurality of pyramidal shaped protrusions including between 6 and 10 side faces.
   Item 20. The display assembly of claim 18, wherein respective tapered sides of the plurality of tapered protrusions are substantially planar.
   Item 21. The display assembly of claim 18, wherein the plurality of tapered protrusions comprise a plurality of tapered protrusions arranged in a hexagonal close packed pattern.
   Item 22. The display assembly of claim 21, wherein the plurality of tapered protrusions define a substantially circular base.
   Item 23. The display assembly of claim 18, further comprising a reflective polarizer layer between the plurality of tapered protrusions and the outer display surface.
   Item 24. The display assembly of claim 23, wherein the reflective polarizer layer comprises a matte coating and reflective polarizer sub-layer, wherein the matte coating is disposed on the reflective polarizer sub-layer opposite that of the plurality of tapered protrusions.
   Item 25. The display assembly of claim 24, wherein the reflective polarizer layer comprises a clear film sub-layer bonded to the reflective polarizer sub-layer via an adhesive sub-layer.
   Item 26. The display assembly of claim 23, wherein the plurality of tapered protrusions are disposed directly on a surface of the reflective polarizer layer.
   Item 27. The display assembly of claim 18, further comprising a liquid crystal display (LCD) defining the outer display surface.
   Item 28. The display assembly of claim 18, further comprising a reflector layer separated from the plurality of tapered protrusions by the lightguide, wherein the reflector layer is configured to reflect light toward the lightguide.
   Item 29. The display assembly of claim 18, further comprising a reflective polarizer layer between the plurality of tapered protrusions and the outer display surface, wherein the plurality of tapered protrusions are disposed directly on the reflective polarizer layer.
   Item 30. The display assembly of claim 18, wherein respective base portions of neighboring protrusions are in substantial contact with each other.
   Item 31. The display assembly of claim 18, wherein a majority of light incident to respective protrusions from the lightguide exhibits an angle with respect to display normal that is greater than approximately 34 degrees.
   Item 32. The system of claim 18, wherein tapered surfaces of the plurality of tapered protrusions exhibit a surface roughness less than approximately a wavelength of visible light.
   Item 33. A film comprising a plurality of substantially pyramidal shaped protrusions, wherein each of the plurality of pyramidal shaped protrusions includes greater than four faces.
   Item 34. The film of claim 33, wherein respective faces of the plurality of substantially pyramidal shaped protrusions are substantially planar.
   Item 35. The film of claim 33, wherein the plurality of substantially pyramidal shaped protrusions comprise a plurality of substantially pyramidal shaped protrusions arranged in a hexagonal close packed pattern.
   Item 36. The film of claim 33, further comprising a reflective polarizer layer disposed on the plurality of substantially pyramidal shaped protrusions , wherein the plurality of substantially pyramidal shaped protrusions taper away from the reflective polarizer layer.
   Item 37. The film of claim 36, wherein the reflective polarizer layer comprises a matte coating and reflective polarizer sub-layer, wherein the matte coating is disposed on a surface of the reflective polarizer sub-layer opposite that of the plurality of substantially pyramidal shaped protrusions.
   Item 38. The film of claim 36, wherein the reflective polarizer layer comprises a clear film sub-layer bonded to the reflective polarizer sub-layer via an adhesive sub-layer.
   Item 39. The film of claim 38, wherein the plurality of substantially pyramidal shaped protrusions are disposed directly on a surface of the clear film sub-layer.
   Item 40. The film of claim 33, wherein the plurality of substantially pyramidal shaped protrusions have a height greater than approximately 10 micrometers.
   Item 41. The film of claim 33, wherein the faces of the plurality of substantially pyramidal shaped protrusions define an apex angle between approximately 50 degrees to approximately 80 degrees.
   Item 42. The film of claim 33, wherein the faces of the plurality of substantially pyramidal shaped protrusions exhibit a surface roughness between approximately 0.1 micrometers root mean squared (rms) and approximately 5 micrometers rms.
   Item 43. The film of claim 33, wherein the faces of the plurality of substantially pyramidal shaped protrusions exhibit a surface roughness less than approximately a wavelength of visible light.
   Item 44. The film of claim 33, wherein respective base portions of neighboring protrusions are in substantial contact with each other.
   Item 45. The film of claim 33, wherein each of the plurality of pyramidal shaped protrusions includes between six and ten faces.
   Item 46. The film of claim 33, wherein the plurality of pyramidal shaped protrusions reduce divergence of light incident to surfaces of respective protrusions in at least one direction and redirect a majority of the incident light such that for incident light propagating along a first direction, the protrusions redirects the majority of light along a second direction different than the first direction.

Various embodiments of the invention have been described. These and other embodiments are within the scope of the following claims.

1. A film comprising:
a reflective polarizer layer; and
a plurality of tapered protrusions disposed on and tapering away from the reflective polarizer layer, wherein the plurality of tapered protrusions comprise at least one of a plurality of substantially conical shaped protrusions or a plurality of pyramidal shaped protrusions including at least four side faces.

2. The film of claim 1, wherein the plurality of tapered protrusions comprise a plurality of tapered protrusions arranged in a hexagonal close packed pattern.

3. The film of claim 1, wherein each tapered protrusion of the plurality of tapered protrusions includes a base surface defining a base area and a tip surface defining a tip area, wherein the tip area is less than approximately 10 percent of the base area.

4. The film of claim 1, wherein the plurality of tapered protrusions are disposed directly on the reflective polarizer layer.

5. The film of claim 1, wherein the plurality of tapered protrusions reducing a divergence of incident light in at least two mutually orthogonal directions.

6. A display assembly comprising:
a light source;
a lightguide;
an outer display surface; and
a plurality of tapered protrusions between the lightguide and outer display surface, and tapering toward the lightguide, wherein the plurality of tapered protrusions comprise at least one of a plurality of substantially conical protrusions or a plurality of pyramidal-shaped protrusions including at least four faces, wherein light from the light source propagates through the light guide into the plurality of tapered protrusions.

7. A film comprising a plurality of substantially pyramidal shaped protrusions, wherein each of the plurality of pyramidal shaped protrusions includes greater than four faces.

8. The film of claim 7, wherein respective faces of the plurality of substantially pyramidal shaped protrusions are substantially planar.

9. The film of claim 7, wherein the plurality of pyramidal shaped protrusions reduce divergence of light incident to surfaces of respective protrusions in at least one direction and redirect a majority of the incident light such that for incident light propagating along a first direction, the protrusions redirects the majority of light along a second direction different than the first direction.
